(19) United States
(12) Patent Application Publication
(10) Pub. No.: US 2017/0193004 A1
(43) Pub. Date: Jul. 6, 2017

(54) ENSURING DATA INTEGRITY OF A RETAINED FILE UPON REPLICATION

(71) Applicant: HEWLETT PACKARD ENTERPRISE DEVELOPMENT LP, Houston, TX (US)

(72) Inventors: Ramesh Kannan KARUPPUSAMY, Bangalore (IN); Rajkumar KANNAN, Bangalore (IN); Jothivelavan SIVASHANMUGAM, Bangalore (IN)

(21) Appl. No.: 15/326,347

(22) PCT Filed: Sep. 5, 2014
(86) PCT No.: PCT/US2014/054349

§ 371 Date: Jan. 13, 2017

(30) Foreign Application Priority Data
Jul. 22, 2014 (IN) 3589/CHE/2014

(51) Int. Cl. G06F 17/30

(52) U.S. Cl. CPC G06F 17/30174; G06F 17/30371; G06F 17/30109; G06F 17/30212

(57) ABSTRACT

Some examples described herein relate to ensuring data integrity of a retained file upon replication. In an example, a checksum of a file may be generated upon transition of the file to a retained state in a source system. The file and the checksum of the file may then be replicated to a target system. Upon replication, a checksum of the replicated file may be generated in the target system. A determination may be made whether the checksum of the replicated file matches with the checksum of the file. If the checksum of the replicated file matches with the checksum of the file, an indication may be provided that the replicated file in the target system is a valid replica of the file retained in the source system.

### BACKGROUND

Increased adoption of technology by businesses has led to an explosion of data. Organizations may be required to store data for various reasons. These may include business reasons, legal and compliance requirements, auditing functions, investigative purposes, etc. A retention enabled file system may allow users to apply retention settings on a file such that the file may be retained in a system for a period set by an administrator for the file.

### BRIEF DESCRIPTION OF THE DRAWINGS

For a better understanding of the solution, embodiments will now be described, purely by way of example, with reference to the accompanying drawings, in which:

FIG. 1 is a block diagram of an example computing device for ensuring data integrity of a retained file upon replication;

FIG. 2 is a block diagram of an example computing environment for ensuring data integrity of a retained file upon replication;

FIG. 3 is a flowchart of an example method for ensuring data integrity of a retained file upon replication; and

FIG. 4 is a block diagram of an example system for ensuring data integrity of a retained file upon replication.

### DETAILED DESCRIPTION

Data retention includes storing an organization's data for various reasons. These may include business or regulatory reasons. To ensure that all necessary data is stored appropriately, an organization may define a data retention policy. The policy may include various guidelines related to data archival. For instance, these may relate to which data will be retained, where data will be retained, how long data will be retained, etc.

A retention enabled file system may allow users to retain files up to a hundred years or more. When a file is retained it can neither be modified nor be deleted. Even after retention period expires the file can't be modified but may become eligible for deletion. This state of the file is called WORM (Write Once Read Many). Many a time, in an archive storage system, some files may become corrupted, for instance, due to prolonged duration of storage, improper maintenance, and environmental conditions. Periodic validation scans may be performed on a file retention system to ensure that the files stored therein remain consistent and uncorrupted. In an instance, a validation scan may involve generating a checksum of a file in the archive system and then regularly validating the file data against the generated checksum. In case a corrupted file is found during validation, the file may be marked as corrupted. However, during data replication of a file system, when files stored in a file retention system are copied to a target system, a corrupted file may also get replicated to the target system. In such case, a validation process on the target system may generate the checksum of a corrupted file. And, since data integrity information (for example, a checksum) of a file is not available on a target system, it may not only lead to an incorrect benchmarking of a checksum (of a corrupted file), but also prevent detection of a corrupted file in a target system.

To prevent these issues, the present disclosure describes various examples for ensuring data integrity of a retained file upon replication to a target system. In an example, a checksum of a file may be generated upon transition of the file to a retained state in a source system. The file and the checksum of the file may then be replicated to a target system. Upon replication, a checksum of the replicated file may be generated in the target system. A determination may be made whether the checksum of the replicated file matches with the checksum of the file. If the checksum of the replicated file matches with the checksum of the file, an indication may be provided that the replicated file in the target system is a valid replica of the file retained in the source system. Thus, the present disclosure may replicate the validation information to a target system so that the validation process on a target site may use the checksum generated in the source system to verify the data integrity of a file object replicated to the target system.

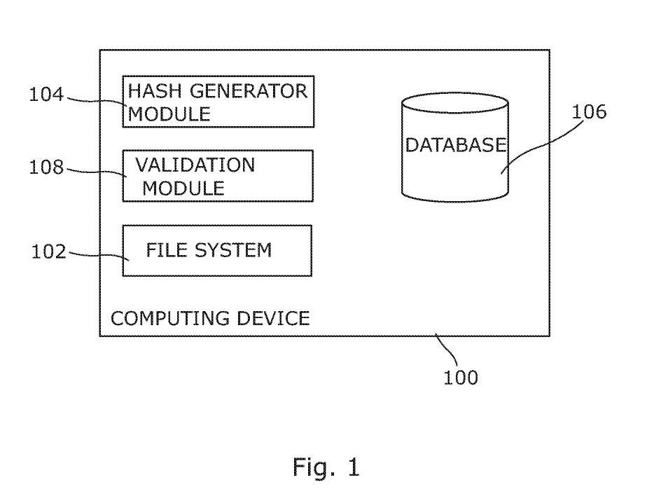

FIG. 1 is a block diagram of an example computing device 100 for ensuring data integrity of a retained file upon replication. Computing device 100 generally represents any type of computing system capable of reading machine-executable instructions. Examples of computing device may include, without limitation, a server, a desktop computer, a notebook computer, a tablet computer, a thin client, a mobile device, a personal digital assistant (PDA), a phablet, and the like.

In an example, computing device 100 may be a storage device or system. Computing device 100 may be a primary storage device such as, but not limited to, random access memory (RAM), read only memory (ROM), processor cache, or another type of dynamic storage device that may store information and machine-readable instructions that may be executed by a processor. For example, Synchronous DRAM (SDRAM), Double Data Rate (DDR), Rambus DRAM (RDRAM), Rambus RAM, etc. Computing device 100 may be a secondary storage device such as, but not limited to, a floppy disk, a hard disk, a CD-ROM, a DVD, a pen drive, a flash memory (e.g. USB flash drives or keys), a paper tape, an Iomega Zip drive, and the like. Computing device 100 may be a tertiary storage device such as, but not limited to, a tape library, an optical jukebox, and the like. In another example, computing device 100 may be a Direct Attached Storage (DAS) device, a Network Attached Storage (NAS) device, a tape drive, a magnetic tape drive, a data archival storage system, or a combination of these devices. In an example, computing device 100 may be a file storage system or file archive system.

In the example of FIG. 1 computing device 100 may include a file system 102, a hash generator module 104, a database 106 and a validation module 108. The term “module” may refer to a software component (machine readable instructions), a hardware component or a combination thereof. A module may include, by way of example, components, such as software components, processes, tasks, co-routines, functions, attributes, procedures, drivers, firmware, data, databases, data structures, Application Specific Integrated Circuits (ASIC) and other computing devices. A module may reside on a volatile or non-volatile storage medium and configured to interact with a processor of a computing device (e.g. 100).

In general, file system 102 may be used for storage and retrieval of data from computing device 100. Typically, each piece of data is called a “file”. File system 102 may be a local file system or a scale-out file system such as a shared file system or a network file system. Examples of a shared file system may include a Storage Area Network (SAN) file system or a cluster file system. Examples of a network file system may include a distributed file system or a distributed parallel file system. File system 102 may include a file(s) that are replicated to the computing device from another computing device (i.e. a source system). In an example, a file replicated to the computing device i.e. a “replicated file” is a copy of a file retained in a source system. In other words, a replicated file may be a copy of a file to which retention settings may have been applied on a source system. Applying retention settings on a file may allow such file to be retained in a system for a period set by a user.

Hash generator module 104 may include instructions to generate a checksum (or hash) of a replicated file in a file system (example, 102), In an instance, the replicated file is a copy of a file retained in a source system. In an instance, when a file is replicated from a source system to computing device 100, a notification event may be generated by file system 102. This notification event acts as a cue for hash generator module 104 to generate a checksum of a replicated file. A checksum (hash) of a replicated file may be generated using a hash algorithm, and stored in database (example, 106). Some non-limiting examples of hash algorithms that may be used for generating a checksum of a file may include SHA, SHA-1, MD2, MD4, and MD5.

Database 106 may be a repository that stores an organized collection of data. In an example, database 106 may store a checksum of the source file of a file replicated to the computing device 100. The checksum of a source file may be generated when the source file transitions to a retained state (i.e. upon application of retention settings) in a source computing device. In an example, the checksum of a source file may be replicated along with the source file to a target computing device (for example, 100). In another example, a source file and a checksum of the source file may be individually replicated to a target computing device (for example, 100). Apart from the generated checksum, the database 106 may also store other attributes of a file (i.e. source file or replicated file) such as, but not limited to, a unique ID of the file, file name, file path, and metadata. Database 106 may include validation results of a validation scan performed on a source file in a source computing device. For instance, such validation scan may include a periodic validation of the contents of a file retained in the source file system 208 (i.e. a source file) against the checksum of the file. In an example, database 106 may be a replica of a database present on a source computing device i.e. a “source database”. A source database may include, for instance, a checksum of a source file on the source computing device, file attributes (such as, file name) of a source file, and results of a validation scan performed on a source file as described earlier.

In an example, database 106 may be a distributed database that provides high query rates and high-throughput updates using a batching process. Database 106 may use a pipelined architecture that provides access to update batches at various points through processing. In an instance, database 106 may be based on a batched update model, which decouples update processing from read-only queries (i.e. query processing task). In this model, the updates may be batched and processed in the background, and do not interfere with the foreground query workload. Database 106 may allow different stages of the updates in the pipeline to be queried independently. Queries that could use slightly out-of-date data may use only the final output of the pipeline, which may correspond to the completely ingested and indexed data. Queries that require even fresher results may access data at any stage in the pipeline. Database 106 may be a metadata database that stores metadata related to unstructured data. Examples of unstructured data may include documents, audio, video, images, files, body of an e-mail message, Web page, or word-processor document. In an example, database 106 may be integrated into file system 106.

Validation module 108 may include instructions to determine whether the checksum of a replicated file matches with the checksum of the original (or source) file. In other words, once a file is replicated from a source computing device to a target computing device (for example, 100), validation module 108 may perform a validation scan on the replicated file. In an instance, such validation is carried out by comparing a checksum of the replicated file, which may be generated by hash generator module 104, with the checksum of the original (source) file present in the database 106 of the target computing device (for example, 100). In response to said determination, if the checksum of a replicated file matches with the checksum of the file retained in a source system, validation module 108 may provide an indication to the system or a user that the replicated file is a valid copy of the file retained in the source system. In other words, the replicated file is not a corrupt copy of the source file. In another example, if the checksum of the replicated file matches with the checksum of the source file replicated to the target computing device, validation module 108 may verify the validation results related to the source file from the database 106. If the verification is unsuccessful, it indicates that the replicated copy is valid, but the source file may have become corrupted. In the event, validation module 108 may send a copy of the valid replicated file to the source system to ensure consistency between file data across source and target systems.

In the event, in response to the aforesaid determination, if the checksum of a replicated file does not match with the checksum of the file retained in a source system i.e. the replicated file is a corrupted file, validation module 108 may verify the validity of the source file by querying the validation results related thereto in the database 106 on the computing device 100. If the source file is found to be a valid file (i.e. uncorrupted), validation module 108 may send information related to the replicated file (for example, a unique ID of the file, file name, file path, metadata etc.) to the source system for again replicating the source file to the target computing device (example, 100). In response, the source system may transmit another copy of the source file to the target system (example, 100). Validation module 108 may perform a periodic validation scan for each file replicated to the target system to ensure that a replicated file is not corrupted over a period of time.

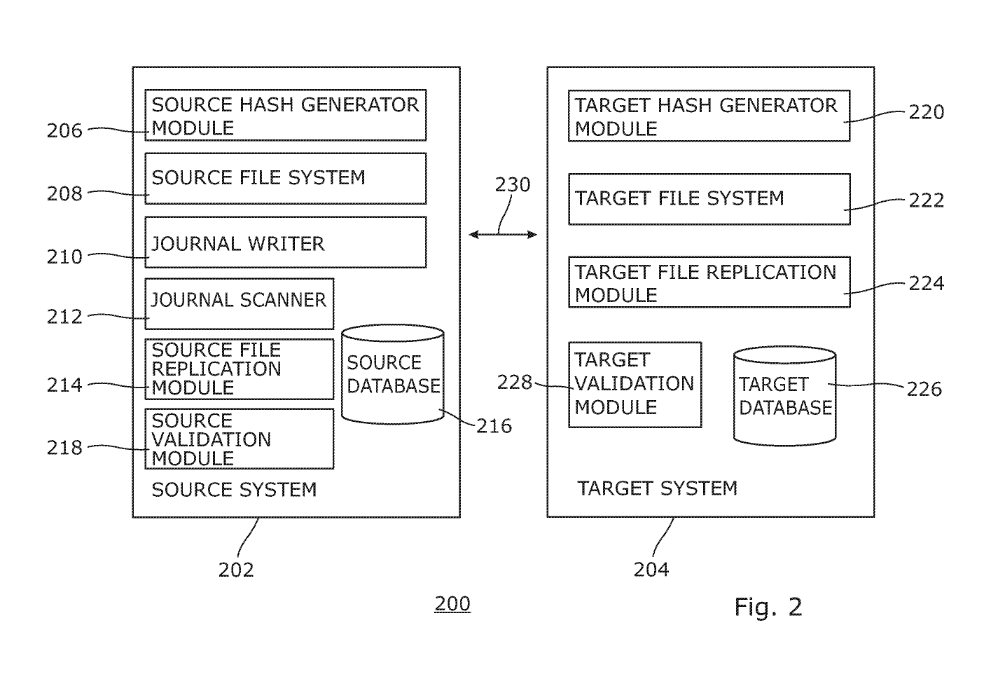

FIG. 2 is a block diagram of an example computing environment 200 that facilitates data integrity of a retained file upon replication. Computing environment 200 may include a source system 202 and a target system 204.

Source system 202 may be directly coupled to target system. In another example, source system 202 may communicate with target system via a computer network 230. Computer network 230 may be a wireless or wired network. Computer network 230 may include, for example, a Local Area Network (LAN), a Wireless Local Area Network (WAN), a Metropolitan Area Network (MAN), a Storage Area Network (SAN), a Campus Area Network (CAN), or the like. Further, computer network 230 may be a public network (for example, the Internet) or a private network (for example, an intranet).

Source system 202 may include a source hash generator module 206, a source file system 208, a journal writer 210, a journal scanner 212, a source file replication module 214, a source database 216, and a source validation module 218.

Source file system 208 may allow a user to apply retention settings on a file such that the file is retained in the system for a period set by the user. Source hash generator module 206 may include instructions to generate a checksum of a file in source file system 208 when the file transitions from a normal state to a retained state. In an instance, when a file transitions to a retained state, a notification event may be generated by source file system 208. This notification event acts as a cue for hash generator module 206 to generate a checksum of a file that transitions to a retained state. Some non-limiting examples of hash algorithms that may be used for generating a checksum of a retained file may include SHA, SHA-1, MD2, MD4, and MD5.

The generated checksum may be sent to a journal writer 210 (present in the file system kernel module) which may include instructions to generate a journal for the checksum generation.

Journal scanner 212 may include instructions to process a journal generated by journal writer 210. Upon processing of a journal for checksum generation, journal scanner 212 may insert the generated checksum into source database 108. Journal scanner 212 may also insert various file attributes such as, but not limited to, a unique ID of the file, file path, etc. in source database 216.

Source hash generator module 206 may include instructions to generate a checksum (hash) of a file when the file transitions from a normal state to a retained state (i.e. upon application of retention settings). Source hash generator module may 206 generate a checksum (hash) of a file by using a hash algorithm. Some non-limiting examples of hash algorithms that may be used for generating a checksum of a file may include SHA, SHA-1, MD2, MD4, and MD5. In an example, the generated checksum may be stored in source database 216.

Source replication module 214 may include instructions to replicate a copy of a file to another computing or storage device (for example, target system 204). Source replication module 214 may also include instructions to replicate a copy of a checksum of a file, generated by source hash generator module 206, to another computing or storage device (for example, target system 204).

Source validation module 218 may include instructions to periodically validate the contents of a file present in the source file system 208 against the checksum of the file, which may be present in the source database 216. The results of such validation may also be stored in the source database 216.

Target system 204 may include a target hash generator module 220, a target file system 222, a target file replication module 224, a target database 226, and a target validation module 228.

In an example, the target system may be analogous to computing device 100, in which like reference numerals correspond to the same or similar, though perhaps not identical, components. For the sake of brevity, components or reference numerals of FIG. 2 having a same or similarly described function in FIG. 1 are not being described in connection with FIG. 2, Said components or reference numerals may be considered alike. For instance, target hash generator module, target file system, target database, and target validation module of FIG. 2 may be analogous to hash generator module, file system, database, and validation module of FIG. 1 respectively, and may perform their respective functionalities as described herein.

Target hash generator module 220 may include instructions to generate a checksum (or hash) of a replicated file in a target system 204. In an instance, the replicated file is a copy of a file retained in a source system 202. A checksum (hash) of a replicated file may be generated using a hash algorithm. Some non-limiting examples of hash algorithms that may be used for generating a checksum of a replicated file may include SHA, SHA-1, MD2, MD4, and MD5.

Target validation module 228 may include instructions to determine whether the checksum of a replicated file in a target system 204 matches with the checksum of its source file, wherein the checksum of the source file is replicated and stored in the target system 204. If it is determined that the checksum of the replicated file matches with the checksum of the source file, target validation module 228 may indicate to a system or a user that the replicated file on the target system is a valid replica of the source file retained on the source system 202.

Target file replication module 224 may include instructions to receive a replica of a file retained in a source system (example, 202). Target file replication module 224 may also include instructions for a source system (example, 202) to again replicate the source file to the target system 204. This may occur, for instance, if the checksum of a replicated file does not match with the checksum of the file retained in a source system, and the target validation module 228 verifies the validity of the source file by querying the validation results related thereto in the target database 226. If the source file is found to be a valid file (i.e. uncorrupted), target file replication module 224 may send information related to the replicated file (for example, a unique ID of the file, file name, etc.) to the source system (example, 202) for again replicating the source file to the target system 204.

Target file replication module 224 may also include instructions to send a copy of the replicated file to the source system (example, 202). This may occur, for instance, if the checksum of the replicated file does not match with the checksum of the source file stored in the source system. It indicates that the replicated file is valid but the source file may be corrupted. In such case, a copy of the valid replicated file may be sent to the source system to ensure consistency between file data across source and target systems.

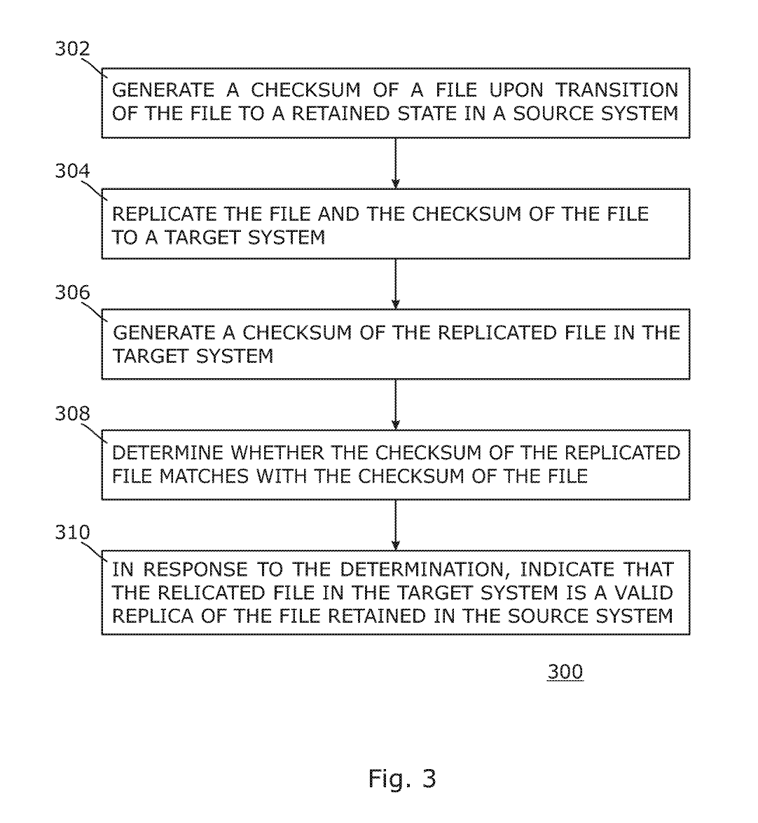

FIG. 3 is a flowchart of an example method 300 for ensuring data integrity of a retained file upon replication to a target system. The method 300, which is described below, may at least partially be executed on a computing device 100 of FIG. 1 or source and target systems (202, 204) of FIG. 2, However, other computing devices may be used as well. At block 302, a checksum of a file may be generated during transition of a file from a normal state to a retained state in a source system. The generated checksum may be stored in a database of the source system, At block 304, the file may be replicated from the source system to a target system. The checksum of the file may also be replicated from the source system to the target system. The checksum of file may be stored in a database of the target system. In an example, the target system is a file retention system. At block 306, a checksum of the file replicated to the target system may be generated in the target system. At block 308, a determination is made whether the checksum of the replicated file matches with the checksum of the file. Said differently, the checksum of the replicated file is compared with the checksum of the file. In response to said determination, if the checksum of the replicated file matches with the checksum of the file, an indication may be provided to a system or a user that the replicated file in the target system is a valid replica of the file retained in the source system (block 310). In an instance, validation results related to the checksum of the file on the source system may be available in the target system. In such case if the checksum of the replicated file matches with the checksum of the file, a determination may be made, based on validation results in the target system, whether the validation of the checksum of the file on the source system is successful or unsuccessful. If it is determined that the validation of the checksum of the file on the source system is unsuccessful, it indicates that the replicated file is valid but the source file may be corrupted. In such case, a copy of the valid replicated file may be sent to the source system to ensure consistency between file data across source and target systems.

In another instance, validation results related to the checksum of the file on the source system may be stored in the source system. In such case if the checksum of the replicated file matches with the checksum of the file, a determination may be made, based on validation results in the source system, whether the validation of the checksum of the file on the source system is successful or unsuccessful. If it is determined that the validation of the checksum of the file on the source system is unsuccessful, it indicates that the replicated file is valid but the source file may be corrupted. In such case, a copy of the valid replicated file may be sent to the source system to ensure consistency between file data across source and target systems.

If the checksum of a replicated file does not match with the checksum of the file retained in the source system, the validity of the file may be verified by querying the validation results related thereto in the database on the target system. If the file is found to be valid, information related to the replicated file (for example, a unique ID of the file, file name, etc.) may be sent to the source system for again replicating the file to the target system.

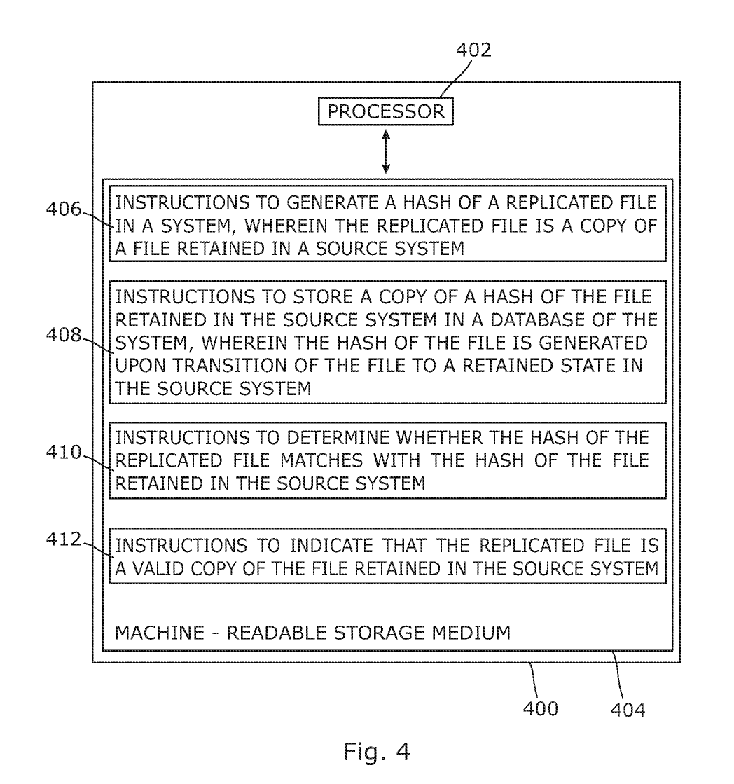

FIG. 4 is a block diagram of an example system 400 for ensuring data integrity of a retained file upon replication to a target system. System 400 includes a processor 402 and a machine-readable storage medium 404 communicatively coupled through a system bus. In an example, system 400 may be analogous to computing device 100 of FIG. 1 or target system 204 of FIG. 2. Processor 402 may be any type of Central Processing Unit (CPU), microprocessor, or processing logic that interprets and executes machine-readable instructions stored in machine-readable storage medium 404. Machine-readable storage medium 404 may be a random access memory (RAM) or another type of dynamic storage device that may store information and machine-readable instructions that may be executed by processor 402. For example, machine-readable storage medium 404 may be Synchronous DRAM (SDRAM), Double Data Rate (DDR), Rambus DRAM (RDRAM), Rambus RAM, etc. or a storage memory media such as a floppy disk, a hard disk, a CD-ROM, a DVD, a pen drive, and the like. In an example, machine-readable storage medium 404 may be a non-transitory machine-readable medium. Machine-readable storage medium 404 may store instructions 406, 408, 410, and 412. In an example, instructions 406 may be executed by processor 402 to generate a hash of a replicated file in a system (for example, 100). In an instance, the replicated file is a copy of a file (i.e. source file) retained in another system (i.e. source system). Instructions 408 may be executed by processor 402 to store a copy of a hash of the source file in a database of the system. In an example, the hash of the source file is generated upon transition of the file to a retained state in the source system. Instructions 410 may be executed by processor 402 to determine whether the hash of the replicated file matches with the hash of the file retained in the source system. Instructions 412 may be executed by processor 402 to indicate that the replicated file is a valid copy of the file retained in the source system if it is determined that the hash of the replicated file matches with the hash of the file retained in the source system. Storage medium 404 may further include instructions to send the replicated file to the source system for again replicating the file to the system if it is determined that the hash of the replicated file does not match with the checksum of the file.

In an example, the storage medium may further include instructions to record information related to the replicated file (for example, a unique ID of the file, file name, etc.) in a list if it is determined that the hash of the replicated file does not match with the checksum of the file. Such instructions may further include instructions to send the list containing information related to the replicated file to the source system. The storage medium may also include instructions for the source system to identify the replicated file from the list and replicate source file of the replicated file from the source system to the system.

For the purpose of simplicity of explanation, the example methods of FIGS. 3 and 4 are shown as executing serially, however it is to be understood and appreciated that the present and other examples are not limited by the illustrated order. The example systems of FIGS. 1, 2 and 4, and method of FIG. 3 may be implemented in the form of a computer program product including computer-executable instructions, such as program code, which may be run on any suitable computing device in conjunction with a suitable operating system (for example, Microsoft Windows, Linux, UNIX, and the like). Embodiments within the scope of the present solution may also include program products comprising non-transitory computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer. The computer readable instructions can also be accessed from memory and executed by a processor.

It may be noted that the above-described examples of the present solution is for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

1. A method for ensuring data integrity of a retained file upon replication, comprising:
receiving, at a target system from a source system, a replicated file corresponding to a file on the source system, and a replicated checksum of the file generated by the source system upon transition of the file to a retained state in the source system;
receiving, at the target system from the source system, replicated results of validating the checksum of the file on the source system;
generating a checksum of the replicated file in the target system;
determining whether the checksum of the replicated file matches with the checksum of the file generated by the source system; and
in response to the determination that the checksum of the replicated file matches the checksum of the file, determining, based on the replicated validations results of the target system, whether validation of the checksum of the file on the source system was successful; and
in response to a determination that the validation was unsuccessful, sending a copy of the replicated file from the target system to the source system.

2. (canceled)

3. The method of claim 1, further comprising:
validating the checksum of the file on the source system; and
replicating results of the validation from the source system to the target system.

4-9. (canceled)

10. A system, comprising:
a processor of a source system; and
a machine-readable storage medium of the source system storing machine readable instructions executable by the processor to:
generate a checksum of a file upon transition of the file to a retained state in the source system;
replicate the file and the checksum of the file to a target system such that the target system stores a replicated file corresponding to the file and the checksum of the file;
validate the checksum of the file on the source system;
in response to the target system determining that the checksum of the file provided to the target system matches a checksum of the replicated file, determine whether the validation of the checksum of the file on the source system was successful; and
after determinations that the checksums match and the validation was unsuccessful, receiving, at the source system, a copy of the replicated file from the target system.

11. A non-transitory machine-readable storage medium comprising instructions executable by a processor of a target system to:
generate a hash of a replicated file in the target system, wherein the replicated file is a copy of a file retained in a source system;
store, in a database of the target system, a copy of a hash of the file generated by the source system upon transition of the file to a retained state in the source system;
store, in the database of the target system, replicated results of validating the hash of the file on the source system, the replicated results received from the source system;
determine whether the hash of the replicated file matches the copy of the hash of the file retained in the source system; and
in response to a determination that the hash of the replicated file does not match the copy of the hash of the file retained in the source system, determine from the replicated results of validating the hash on the source system whether the validation was successful; and
in response to determinations that the checksums do not match and the validation was successful, cause the source system to replicate the file to the target system again.

12. (canceled)

13. The storage medium of claim 11, further comprising instructions executable by the processor of the target system to record file name of the replicated file in a list in response to the determination that the hash of the replicated file does not match the copy of the hash of the file retained on the source system.

14. The storage medium of claim 13, wherein the instructions to cause the source system to replicate the file to the target system again comprise instructions to send the list containing the file name of the replicated file to the source system.

15. (canceled)

16. The non-transitory machine-readable storage medium of claim 11, wherein the instructions to cause the source system to replicate the file to the target system again comprise instructions to:
send information related to the replicated file to the source system for again replicating the file to the target system.

17. The non-transitory machine-readable storage medium of claim 16, wherein the information related to the replicated file includes an identifier associated with the file in the retained state in the source system.

18. The non-transitory machine-readable storage medium of claim 16, wherein the information related to the replicated file includes a file name of the file in the retained state in the source system.

19. The non-transitory machine-readable storage medium of claim 11, further comprising instructions executable by the processor to:
in response to a determination that the hash of the replicated file matches the copy of the hash of the file retained in the source system, determine from the replicated results of validating the hash on the source system whether the validation was successful; and
in response to determinations that the checksums match and the validation was unsuccessful, send a copy of the replicated file from the target system to the source system.

20. The system of claim 10, further comprising:
a processor of a target system; and
a machine-readable storage medium of the target system storing machine readable instructions executable by the processor of the target system to:
receive, at the target system, the replicated file and the checksum of the file generated by the source system;
generate a checksum of the replicated file in the target system;
determining that the checksum of the replicated file matches with the checksum of the file generated by the source system; and
after the determination that the checksums match and a determination by the source system that validation was unsuccessful, send a copy of the replicated file from the target system to the source system.
